(19) United States
(12) Patent Application Publication
(10) Pub. No.: US 2007/0216324 A1
(43) Pub. Date: Sep. 20, 2007

(54) DEMODULATION METHOD OF RESOLVER OUTPUT POSITION SIGNAL

(75) Inventors: Ming-Shing LIU, TAICHUNG (TW); Yi-Cheng SU, TAICHUNG (TW)

Correspondence Address: BANGER SHIA, 204 CANYON CREEK, VICTORIA, TX, 77901, US

(73) Assignee: HIWIN MIKROSYSTEM CORP., Taichung (TW)

(21) Appl. No.: 11/308,348

(22) Filed: Mar. 17, 2006

(51) Int. Cl. H02P 7/06

(52) U.S. Cl. 318/254

(57) ABSTRACT

A demodulation method of a resolver output position signal comprises the steps of: inputting an excitation signal, using a push-pull amplifier circuit to increase fan-out; using a voltage regulator to adjust the amplitude of resolver signals to the same level, for improving resolution; modulating with a subtracter; amplifying the signal with an amplifier circuit for providing signal waveform readable by a resolver to digital converter or a controller.

### BACKGROUND OF THE INVENTION

1. Field of the Invention

The present invention relates to a demodulation of the position signal outputted from a resolver, and more particularly to a demodulation method of the resolver output position signal, which can demodulate the position signal and make the feedback signal accurately readable by the driver, thus improving the resolution.

2. Description of the Prior Art

The working principle of a rotary motor is that the current flows to the stator via a transistor 3-phase inverter and a pulse width modulator (PWM), producing a rotating magnetic field, and then the rotating magnetic field will interact with the permanent magnet of the rotor and generate a torque. The intention of an electronic commutator is to enable the stator generated magnetic field to be maintained in a vertical direction with respect t to the magnetic field of the rotor's permanent magnet, so as to produce a maximum torque. And this intension should be achieved by the electronic commutator via a resolver's feedback. In other words, it should precisely detect the position of the rotor's magnetic electrodes and transmit the position signal to the driver, and then the driver gives an instruction to actuate the coil winds of the stator, enabling the stator generated magnetic field to be maintained in a vertical direction with respect t to the magnetic field of the rotor's permanent magnet, thus producing a maximum torque.

With reference to FIG. 1, a standard signal outputted from a resolver is illustrated. The RDC chips (resolver to digital converter) currently available on the market or the controllers using the resolver as a position signal feedback instrument are only able to receive the standard signal from the resolver shown in FIG. 1.

Besides, U.S. Pat. No. 4,733,117 discloses a method of using windings to convert a 3-phase (phase difference is 120 degrees) a variable reluctance resolver signal, as illustrated in FIG. 2, into a standard 2-phase resolver signal (as shown in FIG. 1), and the method is described as follows:

With reference to FIG. 3, which a circuit diagram of a 3-phase variable reluctance resolver, and the 3-phase signal is represented by the following equations:
Vₐ=Usm (1+Um sin θ)sin Ωt
V_{b}=Usm (1+Um sin (θ+2/3π)sin Ωt
V_{c}=Usm (1+Um sin (θ+4/3π)sin Ωt

According to the method of phase synthesis,
R₁ sin θ=2Vₐ−V_{b}−V_{c}, R₂ cos θ=V_{b}−V_{c}
the Usm*sin Ωt can be eliminated, thus converting the signal outputed from a resolver as shown in FIG. 2, into the standard 2-phase signal shown in FIG. 1. However, the disadvantage of this method is in that the distorted waveform (as shown in FIG. 4) cannot be restored, and thus an error signal will be sent to the RDC, and the position feedback signal can be obtained accurately, which will result in a substantial decrease in resolution.

The present invention has arisen to mitigate and/or obviate the afore-described disadvantages.

### SUMMARY OF THE INVENTION

The primary objective of the present invention is to solve the aforementioned problems by providing a demodulation method of a resolver output position signal, which can demodulate the position signal and make the feedback signal accurately readable by the driver, thus improving the resolution. To achieve this objective, the demodulation method of a resolver output position signal in accordance with the present invention comprises the steps of: inputting an excitation signal; using a push-pull amplifier circuit to increase fan-out; using a voltage regulator to adjust the amplitude of resolver signals to the same level, for improving resolution; demodulating with a subtracter; amplifying the signal with an amplifier circuit for providing signal waveform readable by a resolver to digital converter or a controller.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 illustrates a standard signals outputted from a conventional resolver;

FIG. 2 is an illustrative view of showing the signals from a conventional 3-phase resolver;

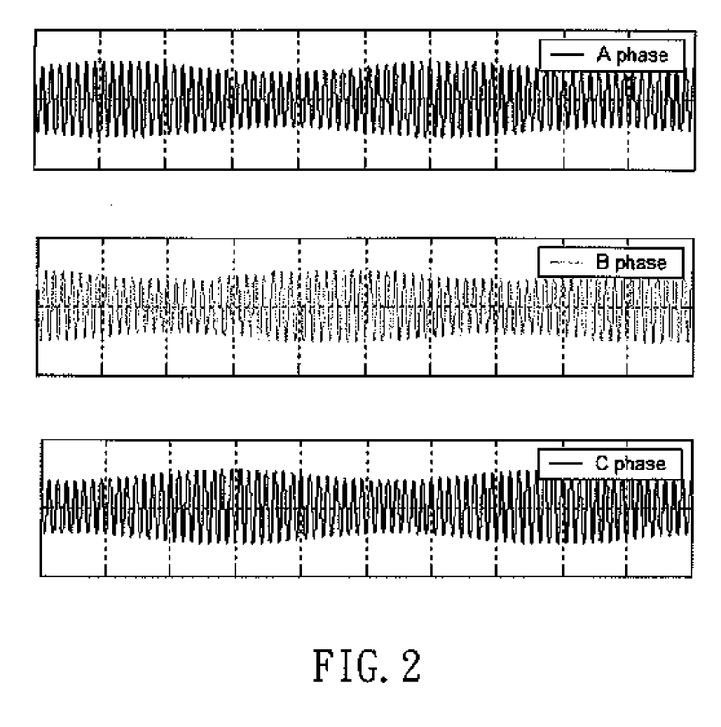

FIG. 3 is a circuit diagram of the conventional 3-phase resolver;

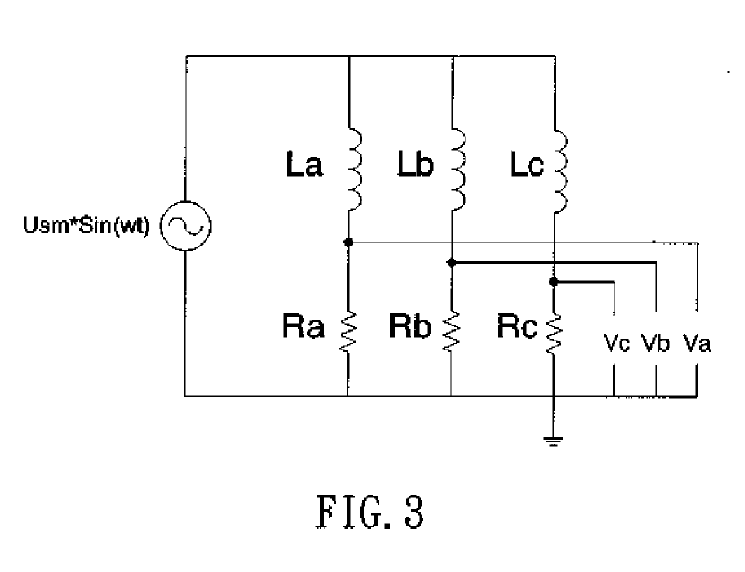

FIG. 4 illustrates the response relation between the conventional amplitude and the time;

FIG. 5 is a flow chart of showing the steps of the demodulation in accordance with the present invention;

FIG. 6 shows the waveform of the A-phase signal in accordance with the embodiment;

FIG. 7 shows the waveform of the B-phase signal in accordance with the embodiment;

FIG. 8 shows the waveform of the C-phase signal in accordance with the embodiment;

FIG. 9 shows the waveform of the D-phase signal in accordance with the embodiment; and

FIG. 10 is a circuit diagram of a 4-phase variable reluctance resolver in accordance with the present invention.

### DETAILED DESCRIPTION OF THE PREFERRED EMBODIMENTS

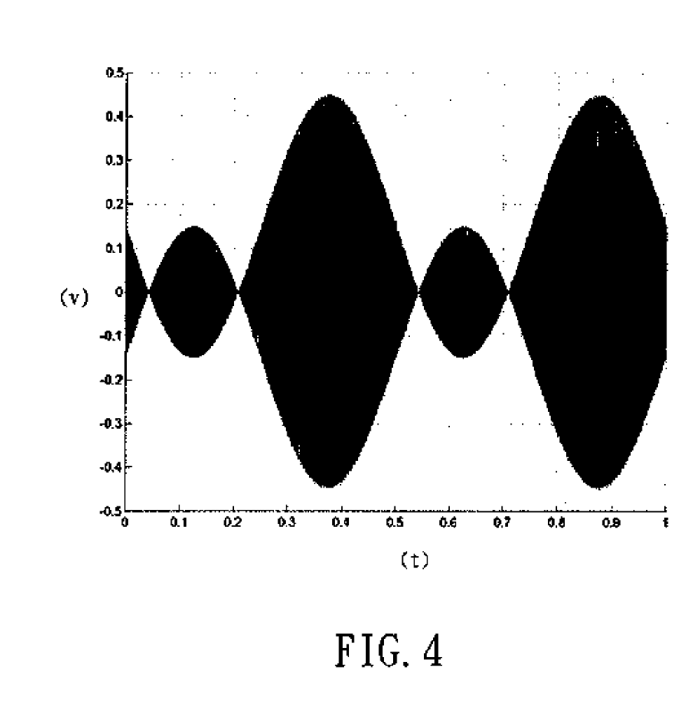

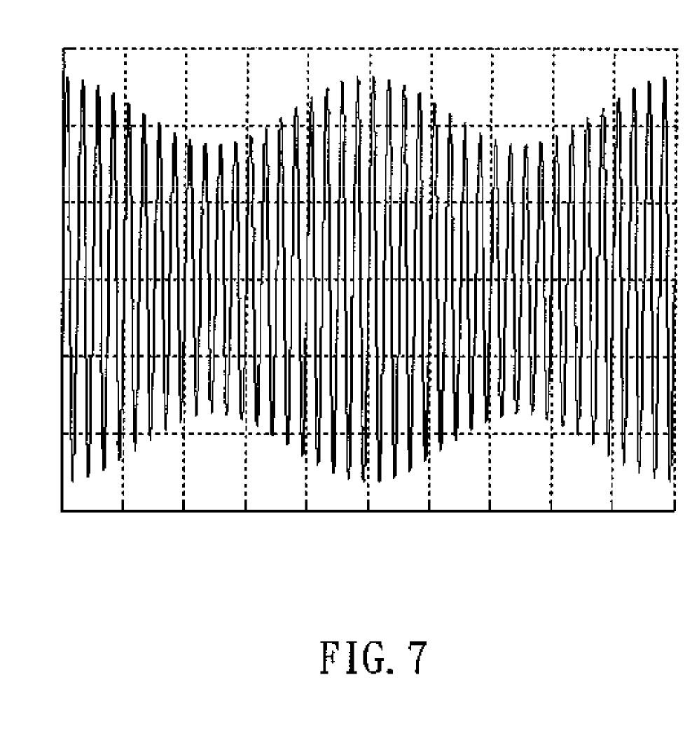

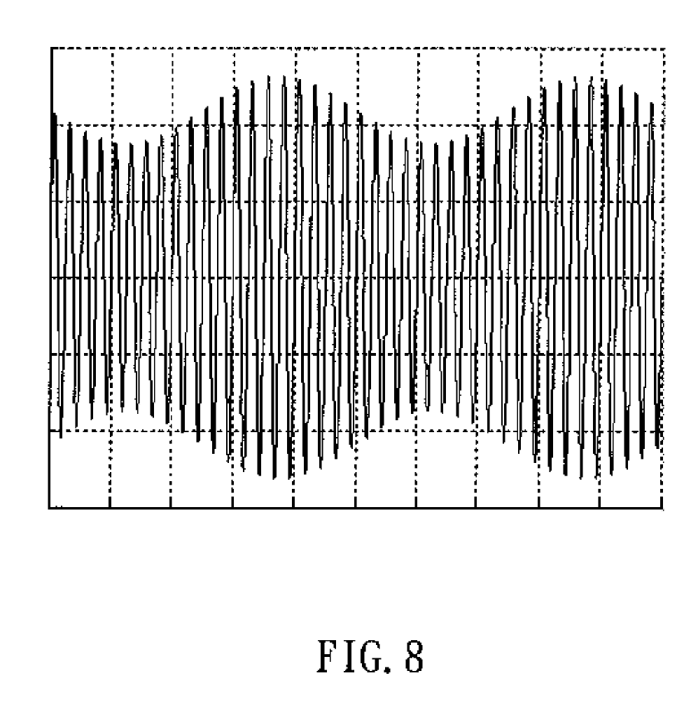

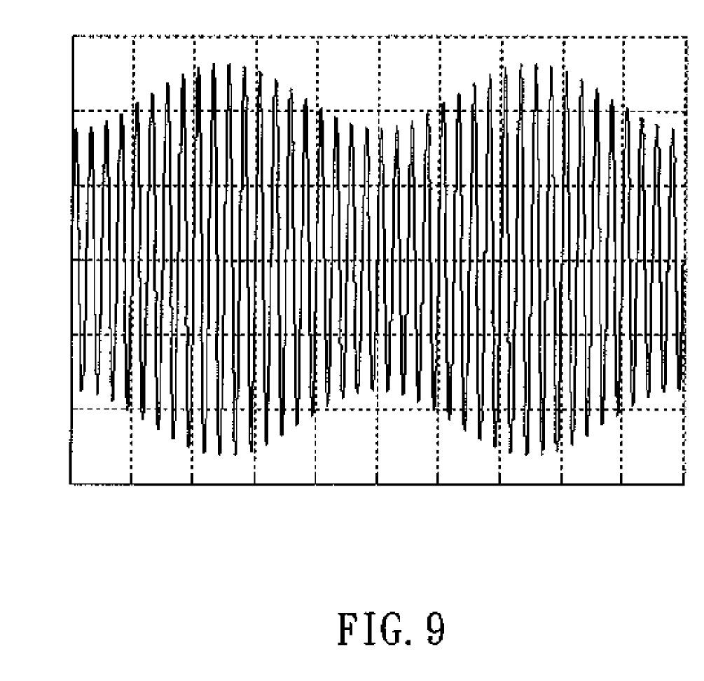

Referring to FIGS. 4-10, which show a preferred embodiment of the present invention, and the embodiment is intended for illustrative purposes only and not as a limitation on the invention.

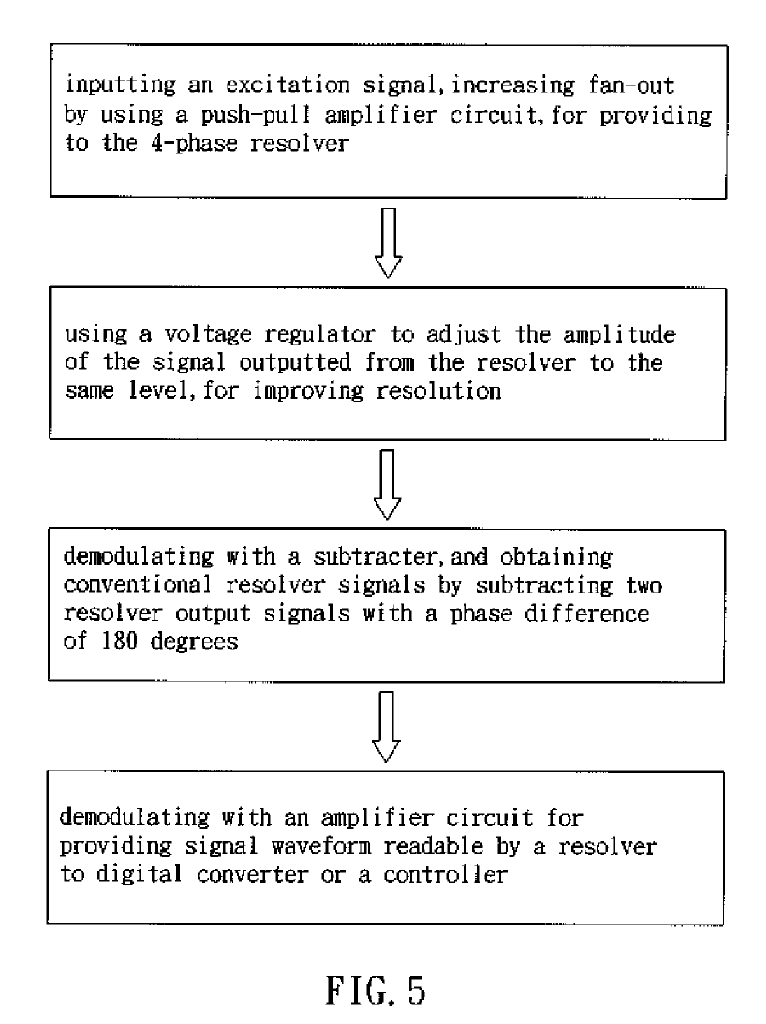

Referring firstly to FIG. 5, a demodulation method in accordance with the present invention comprises the steps of: inputting an excitation signal; using a push-pull amplifier circuit to increase fan-out; using a voltage regulator to adjust the amplitude of the signal outputted from the resolver to the same level, for improving resolution; modulating with a subtracter; amplifying the signal with an amplifier circuit for providing signal waveform readable by the RDC or the controller.

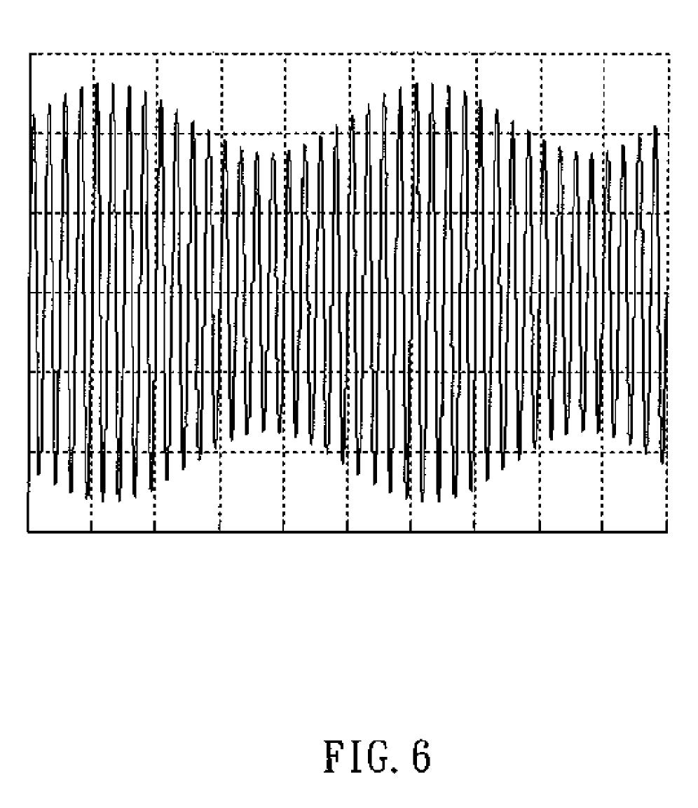

In addition, the resolver in this embodiment is 4-phase resolver with phase shifts of A (O degree), B (90 degrees), C (180 degrees) and D (270 degrees) for example, which output signals as illustrated in FIGS. 6-9, and the signals are represented by the following equations:
Vₐ=Uₐ (1+k₁ sin θ+k₂ sin 2θ+k₃ sin 3θ+ . . . ) sin Ωt
V_{b}=U_{b} (1+k₁ sin (θ+1/2π)+k₂ sin 2(θ+1/2π)+k₃ sin (θ+1/2π)+ . . . ) sin Ωt
V_{c}=U_{c} (1+k₁ sin (θ+π)+k₂ sin 2(θ+π)+k₃ sin (θ+π)+ . . . ) sin Ωt
V_{d}=U_{d} (1+k₁ sin (θ+3/2π)+k₂ sin 2(θ+3/2π)+k₃ sin (θ+3/2π)+ . . . ) sin Ωt

Standard resolver signals can be obtained by subtracting two signals with a phase difference of 180 degrees.
R₁ sin θ=A−C
R₂ cos θ=B−D
Where R₁ and R₂ are constants.

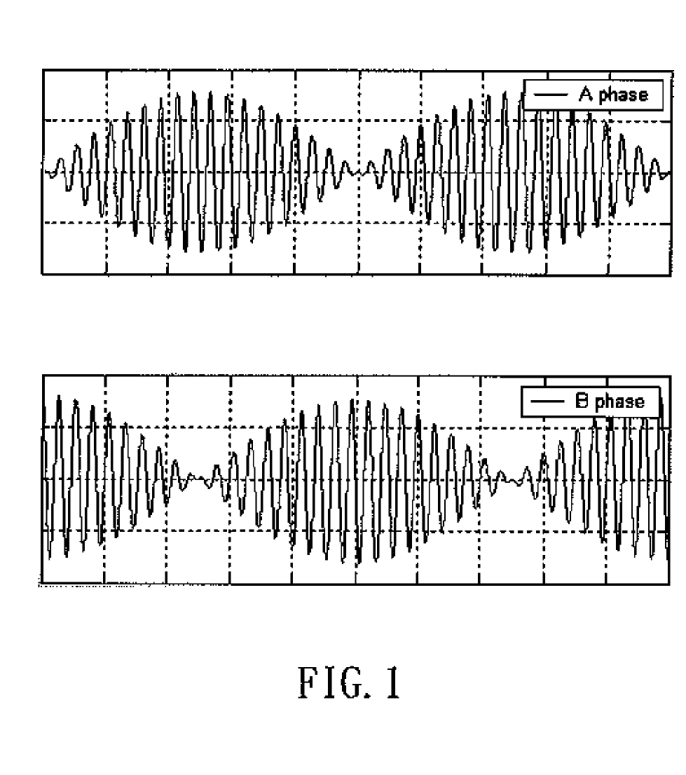

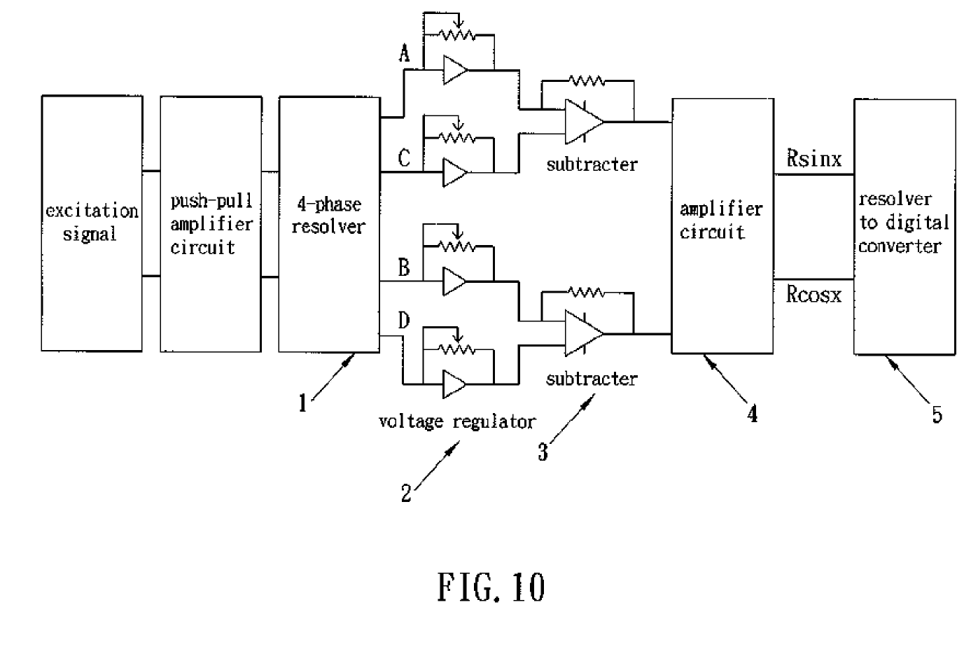

Namely, if four signals are equal in amplitude (namely, Uₐ=U_{b}=U_{c}=U_{d}), standard resolver signals (as shown in FIG. 1) can be obtained by subtracting two signals with a phase difference of 180 degrees (namely, Vₐ−V_{c} and V_{b}−V_{c}). But in fact, four signals are usually unequal in amplitude (Uₐ≠U_{b}≠U_{c}≠U_{d}) as a result of mechanical processing errors and uneveness of the windings of the respective phases, therefore, the obtained standard 2-phase resolver signal will probably distorted, adversely affecting the position analysis result. With reference to FIG. 10, which is a circuit diagram in accordance with the present invention, according to the demodulation steps of the invention, the signals outputted from the 4-phase resolver 1 are initially adjusted to have the same amplitude (namely, Uₐ=U_{b}=U_{c}=U_{d}), and then are subjected to subtraction processing through the subtracter 3 (namely, Vₐ−V_{c} and V_{b}−V_{c}), and finally the signals are amplified by the amplifier circuit 4 for providing signal waveforms readable by the RDC or the controller. Thus, standard undistorted resolver signals can be obtained.

Hence, the method of the present invention can convert 4-phase variable reluctance resolver signal into standard 2-phase resolver signal, and can overcome the low resolution of the prior art resulted from the mechanical processing errors and uneveness of the windings of the respective phases, effectively improving the resolution while reducing the production cost.

To summarize, the present invention has the following advantages: AM (amplitude modulation) signals are optimally equal in amplitude, however, there are always small errors resulted from the mechanical processing errors, the uneveness of the windings of the respective phases, or the harmonic waves. These errors lead to obvious waveform distortion, therefore, the resolver is designed to 4-phase for eliminating the even harmonic waves, and the amplifyer circuit is used to reduce the amplitude difference, so as to obtain the signals that are more close to the conventional resolver signals. Besides, the method of the present invention is also applicable to multi-phase resolver as long as the phase difference of the demodulated signals is 90 degrees and the signals have zero cross function, that is, the signals are readable by RDC.

While we have shown and described various embodiments in accordance with the present invention, it should be clear to those skilled in the art that further embodiments may be made without departing from the scope of the present invention.

What is claimed is:

1. A demodulation method of a resolver output position signal comprising the steps of: inputting an excitation signal; using a push-pull amplifier circuit to increase fan-out; using a voltage regulator to adjust the amplitude of resolver signals to the same level, for improving resolution; demodulating with a subtracter; amplifying the signal with an amplifier circuit for providing signal waveform readable by a resolver to digital converter or a controller.

2. The demodulation method of a resolver output position signal as claimed in claim 1, wherein the resolver signals are outputted from a 4-phase resolver, so that standard resolver signals are obtained by subtracting two signals with a phase difference of 180 degrees.
